(19) United States
(12) Patent Application Publication
(10) Pub. No.: US 2006/0289466 A1
(43) Pub. Date: Dec. 28, 2006

(54) Deicing systems

(75) Inventors: Thomas K. Reusche, Elburn, IL (US); Philip E. Chumbley, Aurora, IL (US); James R. McHugh, Downers Grove, IL (US)

Correspondence Address: MCANDREWS HELD & MALLOY, LTD, 500 WEST MADISON STREET, SUITE 3400, CHICAGO, IL, 60661, US

(73) Assignee: Allied Precision Industries, Inc.

(21) Appl. No.: 11/414,327

(22) Filed: Apr. 28, 2006

Related U.S. Application Data
(60) Provisional application No. 60/677,253, filed on May 3, 2005.
(60) Provisional application No. 60/685,987, filed on May 31, 2005.
(60) Provisional application No. 60/741,836, filed on Dec. 2, 2005.
(60) Provisional application No. 60/754,171, filed on Dec. 27, 2005.

(51) Int. Cl. H05B 3/06

(52) U.S. Cl. 219/507; 219/523

(57) ABSTRACT

Certain embodiments of the present invention provide a deicer system for heating water within a fluid receptacle to prevent ice from forming including a main body configured to be positioned within the fluid receptacle, a heating element adapted to heat the water, a temperature sensor adapted to detect a temperature of the heating element, a switch adapted to activate and deactivate the heating element, and a control unit in communication with the heating element, the temperature sensor, and the switch. The heating element is supported by the main body. The heating element includes a heating coil and a plate. The plate includes one or more fins. The control unit is adapted to control the heating element using the switch based at least in part on a temperature detected by the temperature sensor.

### RELATED APPLICATIONS

The present application relates to and claims the benefit of U.S. Provisional App. No. 60/677,253, entitled “System and Method for Controlling a Deicer,” filed May 3, 2005; U.S. Provisional App. No. 60/685,987, entitled “System and Method for Controlling a Deicer,” filed May 31, 2005; U.S. Provisional App. No. 60/741,836, entitled “Heat Management for a Floating, Embedded-Coil Deicer,” filed Dec. 2, 2005; and U.S. Provisional App. No. 60/754,171, entitled “Surface Coating for an Aluminum Base Deicer,” filed Dec. 27, 2005. The foregoing applications are herein incorporated by reference in their entirety.

### FEDERALLY SPONSORED RESEARCH OR DEVELOPMENT

[Not Applicable]

### MICROFICHE/COPYRIGHT REFERENCE

[Not Applicable]

### BACKGROUND OF THE INVENTION

Embodiments of the present invention generally relate to preventing the formation of ice in water within a receptacle, such as a pond, birdbath, or the like. More particularly, embodiments of the present invention relate to deicing systems.

Heating or deicing systems have commonly been used to maintain unfrozen areas in fluids such as water. For example, deicing systems may be used in water tanks for livestock, fish ponds, and the like. Early deicers burned wood, coal, or gas while most deicers today are electric. A typical deicing system includes a heater coil. The heat from the coil is transferred to the fluid to keep the fluid from freezing. Electric deicers typically range from 1000 to 1500 watts and may include thermostats that are commonly used to turn the unit on or off in order to introduce heat into the fluid when freezing conditions exist.

Many property owners have ponds located within their property. During winter months in colder climates, the ponds tend to freeze over with ice. When the ponds freeze over, toxic gases are trapped under the ice and pose a hazard to fish living within the pond. If the frozen surface is not broken in order to allow toxic gases to escape, the water below the frozen surface may become overly concentrated with nitrates, for example. Thus, the ice typically is broken in order to allow the toxic gases to escape.

In order to gain access to water below the surface for various activities and provide a path for toxic gases to escape, the frozen surface of the water is typically broken, drilled, or the like, in order to provide an accessible path to the water below. However, conventional methods of providing access to the water are typically labor-intensive, time-consuming, and typically do not prevent subsequent freezing.

As an alternative to conventional methods, pond heaters may maintain an ice-free area within a body of water. However, typical pond heaters are expensive to operate because they operate between approximately 1000 and 1500 watts or more, and, as such, may be dangerous.

Deicers typically are one of three types: (1) floating deicers, wherein the heating element is suspended from a floatation device such that it operates near the surface of the fluid; (2) sinking deicers, wherein the deicer rests upon the bottom of the pond or tank, usually attached to a guard such that the heating element is not in direct contact with the bottom; or (3) drain plug deicers mounted through the drain hole in a livestock tank.

Each of these three types has its own advantages and disadvantages. A floating deicer can more accurately measure the temperature at the surface where freezing will occur, thus it can be set more accurately to turn on at the optimum temperature. However, a deicer on the surface is also within reach of animals that may interfere with its operations or attempt to flip it out of the tank.

Sinking deicers, on the other hand, are often out of sight. However, because the deicer is positioned near the bottom of the fluid and freezing occurs at the top, a temperature gradient between the top and bottom of the fluid may exist. As such, the deicer may turn on at a higher temperature and heat more of the fluid, thereby having a reduced efficiency when compared to a floating deicer.

Drain plug deicers conveniently mount through the drain hole of a livestock tank where they are out of reach of animals and the cord can be protected. However, they also share the disadvantages of a sinking deicer, and have the additional disadvantage of requiring the tank to be drained in order to install the unit.

Different consumers will have their own preference for the type of deicer to use. However, it is not always known which type will work best for a particular application until one or more of the types have been tried. Therefore, a deicer that can be converted from a floater to a sinker would combine both types into one device and give greater flexibility to the user.

Deicers typically contain a thermostat to activate the heating element whenever the fluid temperature falls to a point where freezing may occur. The following discussion assumes the fluid is water, with a freezing point of 32 degrees Fahrenheit (F). In deicers with thermostats, the thermostat will normally turn on at around 40 degrees F. and will turn off after the water temperature has risen a number of degrees. While the water will not freeze until it reaches 32 degrees F., the set point for turning on the thermostat is usually situated around 40 degrees F. to accommodate the uncertainty in accurately determining the set point during production. That is, the set points of a batch of thermostats designed to turn on at 40 degrees F. may actually have a spread of +/−7 degrees F. around that temperature.

Thermostatically-controlled deicers include a thermostat that is placed in series with the heating element. The deicers are normally preset to turn on when the fluid temperature reaches a value approaching the freezing point and turn off when the fluid temperature reaches a value tens of degrees above the freezing point. The thermostat may include bimetal arms that serve as the electrical switch for the deicer. Thus, no additional components are required. The thermostat also serves as a safety device when a thermal path is provided from the heating element to the thermostat such that it will shut off if excess heat is detected. Excess heating may occur if the heater is removed from the fluid, for example.

Traditional deicers only allow water to flow around the outer edges and one face of a heating element or plate. Traditional deicers typically have a flat disk as a plate. Therefore, traditional deicers have limited surface area on the plate with which to transfer heat from a heating element to the water. Thus, there is a need for more effective transfer of heat to a fluid.

In a typical deicing system, water may enter the cavity in which the float resides. However, the water is stagnant, in that it does not flow through the cavity around the float. Typically, the heater forms the bottom side of the cavity. Thus, the heat produced by the heater in a typical deicing system becomes trapped in the cavity with the float. As mentioned, the prolonged exposure to elevated temperatures and/or temperature spikes may degrade the float over time, causing it to lose buoyancy. When the heater is activated, heat is generated. The heat generated by the heater may raise the temperature of the float, which is in close proximity to the heater, to a temperature of about 140 degrees F. or higher. If the deicer is removed from the fluid receptacle while the heater is activated, the temperature of the float may rise to over 200 degrees F. The float may melt and/or degrade when exposed to temperatures in this range. For example, polystyrene foam may typically melt around 200 degrees F. Thus, prolonged exposure to an elevated temperature, or temperature spikes up to and beyond 200 degrees F., may result in the melting of portions of the material in the float. If portions of the float melt, the volume of the float is reduced, thus reducing buoyancy. Thus, a floating deicer may lose buoyancy over time and may eventually no longer be buoyant and will sink to the bottom of the fluid receptacle. Because floating deicers and sinking deicers often have different operating parameters, when a floating deicer sinks due to the loss of buoyancy, it may operate less efficiently, and may be unable to prevent the formation of ice. Thus, it is desirable to prevent heat from collecting around the float that may result in damage to the float and loss of buoyancy.

Current deicers may employ a calorimeter rod embedded within an aluminum base to spread heat out over a larger surface area so that the average temperature of the aluminum surface is lowered for a given amount of heat when compared to a bare calorimeter rod. However, encasing the rod in aluminum also presents potential problems due to the presence of the aluminum. In particular, pitting of the aluminum material is often found when the deicer is operated. A major cause of the pitting is the reaction of chlorine ions in the water with the aluminum. This reaction is exacerbated by the heating of the aluminum when the deicer is energized. The pitting can cause a general degradation of the deicer performance leading to premature failure of the unit.

Some deicers employed anodizing of the aluminum surface in order to suppress the reaction between the aluminum and water-borne ions. However, while the anodizing serves to retard the reaction, it does not fully stop the reaction and the coating is easily defeated by scratching or tarnishing of the anodized surface. Thus, an improved coating for the aluminum surface in order to suppress the reaction with ions in the water is highly desirable.

Thus, there is a need for more effective transfer of heat to a fluid from a heater in a deicer. In addition, it is desirable to prevent heat from collecting around the float that may result in damage to the float and loss of buoyancy. Further, an improved coating for the aluminum surface in order to suppress the reaction with ions in the water is highly desirable. Therefore, there exists a need for improved deicing systems.

### BRIEF SUMMARY OF THE INVENTION

Certain embodiments of the present invention provide a deicer system for heating water within a fluid receptacle to prevent ice from forming including a main body configured to be positioned within the fluid receptacle, a heating element adapted to heat the water, a temperature sensor adapted to detect a temperature of the heating element, a switch adapted to activate and deactivate the heating element, and a control unit in communication with the heating element, the temperature sensor, and the switch. The heating element is supported by the main body. The heating element includes a heating coil and a plate. The plate includes one or more fins. The control unit is adapted to control the heating element using the switch based at least in part on a temperature detected by the temperature sensor.

Certain embodiments of the present invention provide a deicer system for heating water within a fluid receptacle to prevent ice from forming including a main body configured to be positioned within the fluid receptacle, a heating element adapted to heat the water, a float adapted to make the deicing system buoyant, and a heat shield located at least in part between the heating element and the float. The heating element is supported by the main body. The heating element includes a heating coil and a plate.

Certain embodiments of the present invention provide a deicer system for heating water within a fluid receptacle to prevent ice from forming including a main body configured to be positioned within the fluid receptacle and a heating element adapted to heat the water. The heating element is supported by the main body. The heating element includes a heating coil and a plate. The plate includes fins to increase the surface area of the plate. The plate is adapted to allow the water to flow over top, bottom, and side surfaces of the plate.

### BRIEF DESCRIPTION OF SEVERAL VIEWS OF THE DRAWINGS

FIG. 1 illustrates a front perspective view of a deicing system according to an embodiment of the present invention.

FIG. 2 illustrates a bottom perspective view of the deicing system according to an embodiment of the present invention.

FIG. 3 illustrates a top view of a heater for a deicing system according to an embodiment of the present invention.

FIG. 4 illustrates a front view of a deicing system according to an embodiment of the present invention.

FIG. 5 illustrates a front view of a deicing system according to an embodiment of the present invention.

FIG. 6 illustrates a front view of a temperature sensor mounting component according to an embodiment of the present invention.

FIG. 7 illustrates a bottom view of a temperature sensor mounting component according to an embodiment of the present invention.

FIG. 8 illustrates a top view of a heater for a deicing system according to an embodiment of the present invention.

FIG. 9 illustrates a front cross-sectional view of a deicing system according to an embodiment of the present invention.

The foregoing summary, as well as the following detailed description of certain embodiments of the present invention, will be better understood when read in conjunction with the appended drawings. For the purpose of illustrating the invention, certain embodiments are shown in the drawings. It should be understood, however, that the present invention is not limited to the arrangements and instrumentality shown in the attached drawings.

### DETAILED DESCRIPTION OF THE INVENTION

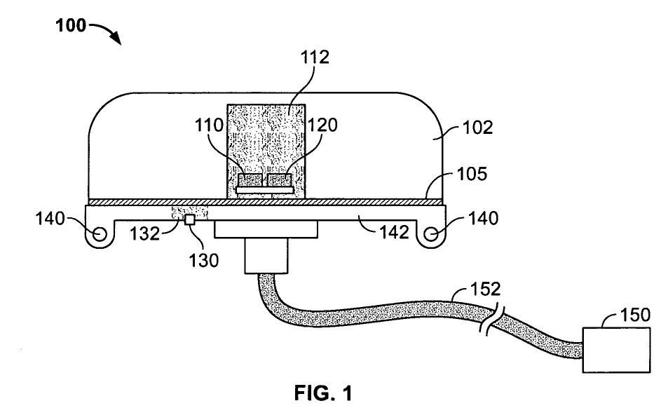

FIG. 1 illustrates a front perspective view of a deicing system 100 according to an embodiment of the present invention. The deicing system 100 includes a main body 105 configured to be positioned within a fluid receptacle. The main body 105 may include an annular frame or support, such as a ring, for example. The main body 105 supports a control unit 110, a switch 120, a temperature sensor 130, a heating element 140, and a power input component 150. In addition, as illustrated in FIG. 1, the deicing system 100 may include a float 102, an electronics cavity 112, a thermal isolating material 132, a plate 142, and a power cord 152. In certain embodiments, one or more of the elements illustrated in FIG. 1 may not be included.

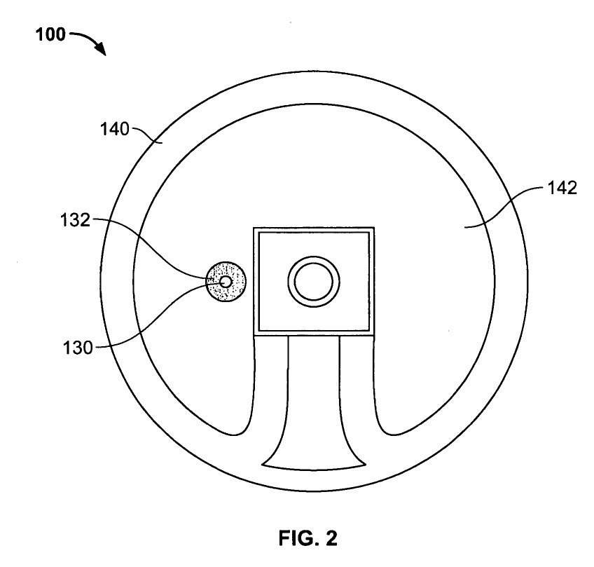

FIG. 2 illustrates a bottom perspective view of the deicing system 100 according to an embodiment of the present invention. Referring to FIGS. 1 and 2, the control unit 110 is in electrical communication with the switch 120 and the temperature sensor 130. The power input component 150 is electrically coupled to the heating element 140. The power input component 150 may be electrically coupled to the heating element 140 through the power cord 152, for example. Further, the power input component 150 may be electrically coupled to the heating element 140 through the switch 120, for example.

In operation, the control unit 110 activates and/or deactivates the heating element 140 based at least in part on a temperature sensed by the temperature sensor 130. That is, the control unit 110 uses the switch 120 to control the flow of power from the power input component 150 to the heating element 140. When power flows to the heating element 140, the heating element 140 is activated to generate heat. When power is prevented from flowing to the heating element 140, the heating element 140 is deactivated, thereby not generating heat.

The control unit 110 is adapted to control the heating element 140. In certain embodiments, the control unit 110 controls the heating element 140 using the switch 120. As discussed above, the control unit 110 may use the switch 120 to activate and/or deactivate the heating element 140. In certain embodiments, the control unit 110 is adapted to control the heating element 140 based at least in part on a predetermined temperature, such as a stored temperature value within the control unit 110. The temperature may be a temperature determined and/or detected by temperature sensor 130, for example. In certain embodiments, the control unit 110 is adapted to control the heating element 140 based at least in part on a time interval. For example, the control unit 110 may activate the heating element 140 for a calculated period of time.

In certain embodiments, the control unit 110 includes a processor or microprocessor. The control unit 110 may include an integrated circuit and/or be implemented using one or more discrete logic components. For example, the control unit 110 may be implemented using one or more chips including gates such as AND, OR, NAND, and NOR gates. The control unit 110 may include more than one processor, microprocessor, and/or integrated circuit. For example, different functions and/or capabilities of the control unit 110 may be handled by different processors, microprocessors, and/or integrated circuits.

In certain embodiments, the control unit 110 is adapted to read and/or determine a temperature through the temperature sensor 130. The temperature may be a fluid temperature, air temperature, a temperature of all or a section of the heating element 140 and/or the plate 142, for example. Further, the control unit 110 may be capable of tracking elapsed time. For example, the control unit 110 may be capable of determine how long the heating element 140 has been activated. As another example, control unit 110 may be capable of determining and/or measuring the number of milliseconds and/or microseconds between temperature readings/determinations. In certain embodiments, the control unit 110 may read and/or determine the temperature using more than one temperature sensor. For example, the control unit 110 may average temperature readings from multiple temperature sensors. Alternatively, the control unit 110 may read and/or determine more than one temperature using more than one sensor. For example, the control unit 110 may read an air temperature from one sensor and a fluid temperature from another sensor.

The control unit 110 may be adapted to detect a dangerous condition such as an over-temperature condition. For example, one or more temperature sensors 130 may be monitored by the control unit 110 to deactivate the heating element 140 when the heating element 140 reaches a critical temperature. If some portion or section of the heating element 140 and/or the plate 142 becomes located outside of a fluid or exposed, the heating element 140 and/or the plate 142 may overheat. The overheated condition may be detected by the control unit 110, which may in turn deactivate the heating element 140 to prevent damage to the deicing system 100 and/or to other animals, persons, and/or objects near the deicing system 100.

The switch 120 may control the flow of power to heating element 140, for example. The switch 120 may be used to activate and/or deactivate the heating element 140 by controlling the flow of power to the heating element 140, for example. The switch 120 is controlled by the control unit 110, for example.

The control unit 110 may be configured and/or programmed such that the heating element 140 is activated when the surface temperature of the fluid approaches the freezing point. For example, when utilized as a “sinking” deicer, the temperature gradient between the top and bottom of the fluid container (e.g., a tank or pond) may be such that the control unit 110 is programmed to activate the heating element 140 at a temperature several degrees higher than it would if the deicing system 100 was floating on the surface. The deicing system 100 may utilize different operating parameters based at least in part on whether the deicing system 100 is operating as a “floating” deicer or a “sinking” deicer, for example. The operating parameters may include, for example, activation temperature(s), deactivation temperature(s), rate of temperature change, and/or amount of time heating element 140 is activated.

The temperature sensor 130 is adapted to determine and/or detect a temperature. The temperature sensor 130 may be adapted to determine the temperature of a fluid, an air temperature, a temperature of heating element 140, and/or a temperature of plate 142, for example. In certain embodiments, one or more temperature sensors may be included in the deicing system 100. For example, the deicing system 100 may include a temperature sensor 130 for determining fluid temperature and a temperature sensor 130 for determining air temperature. Moreover, the temperature sensor 130 may be adapted to communicate the detected and/or determined temperature to the control unit 110. The resolution or sensitivity of the temperature sensor 130 may be selected to be on the order of 1 degree F., for example. Alternatively, the resolution or sensitivity of the temperature sensor 130 may be selected to be on the order of 0.2 degrees F.

Although the above discussion refers to the determination of a temperature, it is to be understood that the temperature sensor may actually determine and/or measure only a current or voltage, for example, that is correlated and/or calibrated to represent a particular temperature. The temperature sensor 130 may include one or more of a thermistor, thermometer, thermocouple, resistance temperature detector, silicon bandgap temperature sensor, and/or other component adapted to create a signal that may be measured electronically and/or electrically as a function of temperature.

The temperature sensor 130 may be thermally isolated from one or more elements of the deicing system 100. For example, the temperature sensor 130 may be thermally isolated from the heating element 140 by the thermally isolating material 132. Thus, the temperature sensor 130 may determine the temperature of a fluid while the effect of heating element 140 is reduced due to the thermal isolation. The thermally isolating material 132 may include epoxy or other material with effective thermal insulation properties, for example.

The heating element 140 is adapted to transfer heat to a fluid. That is, the heating element 140 is adapted to heat the fluid. The heating element 140 may be a calorimeter rod, for example. The heating element 140 may be connected, embedded, encased, enclosed, in whole or in part, within the plate 142. The heating element 140 may be thermally coupled to the plate 142. The plate 142 may be aluminum, copper, or other element, alloy, or material capable of transferring heat from heating element 140 to a fluid.

The power input component 150 is adapted to provide power to the deicing system 100. The power input component 150 may be electrically coupled and/or connected to other components of the deicing system 100, such as the heating element 140 and/or the control unit 110. The power input component 150 may be electrically coupled to the deicing system by the power cord 152, for example. In certain embodiments, the power input component 150 includes a plug, outlet, and/or receptacle for power from a standard alternating current (AC) power source. Alternatively, the power input component 150 may draw power from a solar cell, a battery, and/or a standard electrical outlet.

In certain embodiments, some or all of the control unit 110 is located in the power input component 150. For example, the control unit 110 may include a microprocessor located in the power input component 150 that controls the operation of deicing system 100 over wires in power cord 152. In certain embodiments, the power input component includes a temperature sensor. The temperature sensor may be an air temperature sensor, for example. For example, the temperature sensor may be adapted to determine, detect, and/or compute an air temperature outside of a fluid. The temperature sensor may be monitored by the control unit 110, for example.

As mentioned above, the deicing system 100 may include the float 102. The float 102 may allow the deicing system 100 to be buoyant and/or to float in a fluid. For example, the float 102 may include one or more pieces of polystyrene or polyurethane. For example, the float 102 may be a formed piece of Styrofoam™, an air filled elastic tube or bladder, or the like. In certain embodiments, the float 102 may include and/or be enclosed by a cover. For example, the float 102 may be enclosed by a plastic cover which secures the float 102 to one or more other elements of deicing system 100. Thus, the float 102 may allow the deicing system 100 to act as a “floating” deicer. In certain embodiments, the float 102 is not present in the deicing system 100. Thus, the deicing system 100 may act as a “sinking” deicer. In certain embodiments, the float 102 is detachable. The float 102 may be adapted to be re-attached to the deicing system 100 after it has been removed. For example, the cover may include tabs or latches to secure the float 102 to the deicing system 100, allowing the float 102 to be attached or detached as desired. Thus, the deicing system 100 may be converted between “floating” and “sinking” configurations.

In certain embodiments, a mode sensor is monitored by the control unit 110. The mode sensor may include, for example, a temperature, pressure, tip, tilt, and/or water sensor. The control unit 110 may be adapted to determine whether the deicing system is submerged or floating based at least in part on the mode sensor, for example.

The electronics cavity 112 may provide a compartment for some or all of the electronics and/or electrical components of the deicing system 100. For example, some or all of control unit 110 and/or some or all of switch 120 may be located in the electronics cavity 112. The electronics cavity 112 may be fluid-resistant and/or fluid-proof, for example. For example, the electronics cavity 112 may be water-resistant and/or water-proof. In certain embodiments, the electronics cavity 112 is at least partially filled and/or sealed with a water-resistant material. In certain embodiments, the electronics cavity 112 is filled at least in part with an epoxy to protect the electronics from damage and/or malfunction by a fluid.

The switch 120 may be a relay or a latching relay, for example. As discussed above, the relay may be controlled by the control unit 110 to activate and/or deactivate the heating element 140. Optionally, the switch 120 may be a semiconductor switch, such as a triac. As discussed above, the triac may be controlled by the control unit 110 to activate and/or deactivate the heating element 140. The triac may be used to clip the power cycle and/or strobe power to the heating element 140, for example. In certain embodiments, the switch 120 is composed of both a relay and a triac, where one controls the other, for example.

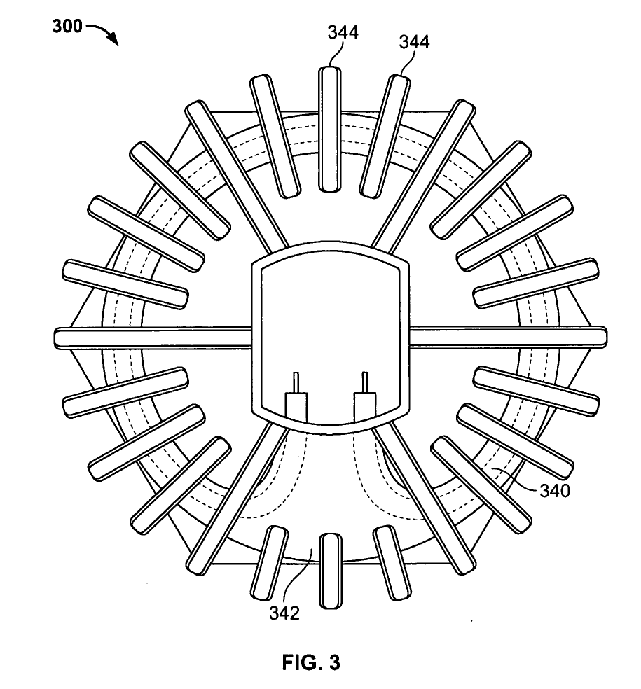

FIG. 3 illustrates a top view of a heater 300 for a deicing system according to an embodiment of the present invention. The heater 300 includes a heating element 340, a plate 342, and one or more fins 344. The heating element 340 is connected, embedded, encased, enclosed, in whole or in part, within the plate 342. The heating element 340 is thermally connected and/or coupled to the plate 342. The plate 342 may be aluminum, copper, or other element, alloy, or material capable of transferring heat from heating element 340 to a fluid. The one or more fins 344 are thermally connected and/or coupled to the plate 342.

The deicing system including the heater 300 may be similar to the deicing system 100, described above. The heating element 340 may be similar to the heating element 140, described above. The plate 342 may be similar to the plate 142, described above.

In operation, the plate 342 is thermally coupled and/or connected to the one or more fins 344 to increase the effective surface area in contact with the water. The increased surface area allows for increased heat transfer from the heating element 340 to the water.

Traditional deicers only allow water to flow around the outer edges and one face of a heating element or plate. Traditional deicers typically have a flat disk as a plate. The fins 344 of the heater 300 allow water to flow over the top of the plate 342, in addition to around the outer edges and below the plate 342. That is, water may flow across more of the surfaces of the heater 300, including the additional area provided by the fins 342.

The heating element 340 of the deicing system including the heater 300 may operate at 1500 watts. Due to the increased surface area of the plate 342 and fins 344, the watts per square inch of the heater 300 may be less than the watts per square inch of a traditional deicer running at 1250 watts. That is, even though the heater 300 may operate at a higher power rating, it may be cooler than a traditional deicer running at a lower power rating. For example, a deicing system including the heater 300 may operate at about 1000 watts and may dissipate about 8 watts per square inch. As another example, a deicing system including the heater 300 may operate at about 1250 watts and may dissipate about 10 watts per square inch. As another example, a deicing system including the heater 300 may operate at about 1500 watts and may dissipate about 12.5 watts per square inch. As another example, a deicing system including the heater 300 may operate at about 1500 watts and may dissipate about 16 watts per square inch.

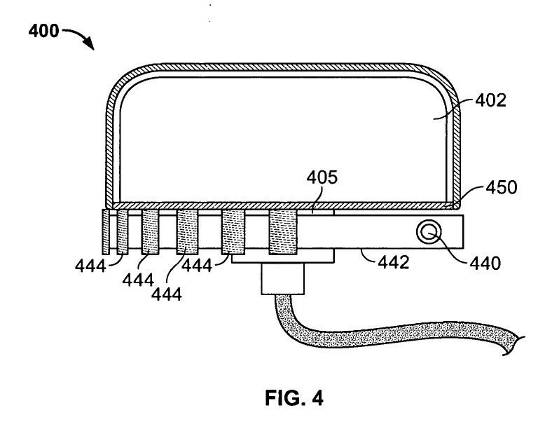

FIG. 4 illustrates a front view of a deicing system 400 according to an embodiment of the present invention. The deicing system 400 includes a main body 405 configured to be positioned within a fluid receptacle. The main body 405 supports a float 402, a heating element 440, a plate 442, one or more fins 444, and a heat shield 450. In certain embodiments, one or more of the elements illustrated in FIG. 1 may not be included.

The deicing system 400 may be similar to the deicing system 100, described above. The main body 405 may be similar to the main body 105, described above. The float 402 may be similar to the float 102, described above. The heating element 440 may be similar to the heating element 140 and/or the heating element 340, described above. The plate 442 may be similar to the plate 142 and/or the plate 342, described above. The fins 444 may be similar to the fins 344, described above.

In operation, the heat shield 450 acts as a thermal barrier between the float 402 and the heating element 440, the plate 442, and/or the fins 444. The heat shield 450 is positioned between the float 402 and the heating element 440, the plate 442, and/or the fins 444.

The heat shield 450 may be a non-porous plate, for example. The heat shield 450 may be made of materials such as plastic or aluminum foil. Thus, the heat shield 450 is adapted to create a barrier to convection and/or radiation heat flow between the heat source and the float 402. If the heat shield 450 is made of a thermally insulating material such as plastic or glass, the heat shield 450 may additionally be a barrier to heat transfer by conduction. Thus, the heat shield 450 is adapted to prevent heat from the heating element 440, plate 442, and/or fins 444 from reaching the float 402.

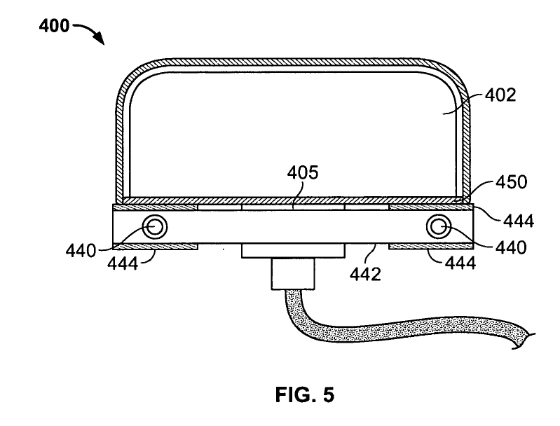

FIG. 5 illustrates a front view of a deicing system 400 according to an embodiment of the present invention. More particularly, FIG. 5 illustrates the deicing system 400 of FIG. 4 and the flow of water over the top surface of the plate 442. In certain embodiments, the effectiveness of the heat shield 450 may be improved by allowing water to flow between the heating element 440, plate 442, and/or fins 444 and the float 402. Thus, by allowing water to flow over all or a portion of the top of the heating element 440, plate 442, and/or fins 444, the heat generated in that region is carried away by the water. In addition to increasing the effectiveness of the heat shield 450 and reducing the heat transferred to the float 402, allowing the water to flow over the top of the heating element 440, plate 442, and/or fins 444 also improves the transfer of heat to the water, thereby reducing the overall surface temperature of the heating element 440, plate, 442, and/or fins 444, similar to the use of fins described above in reference to the heater 300.

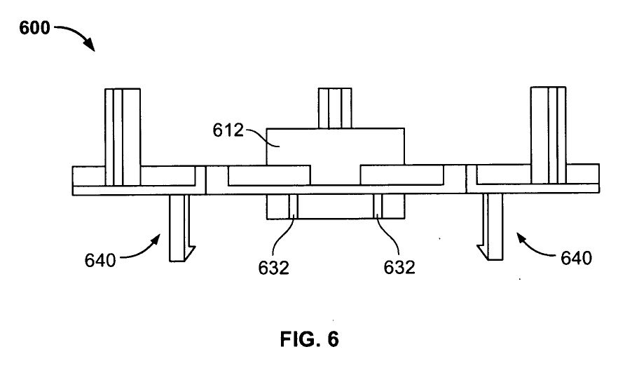

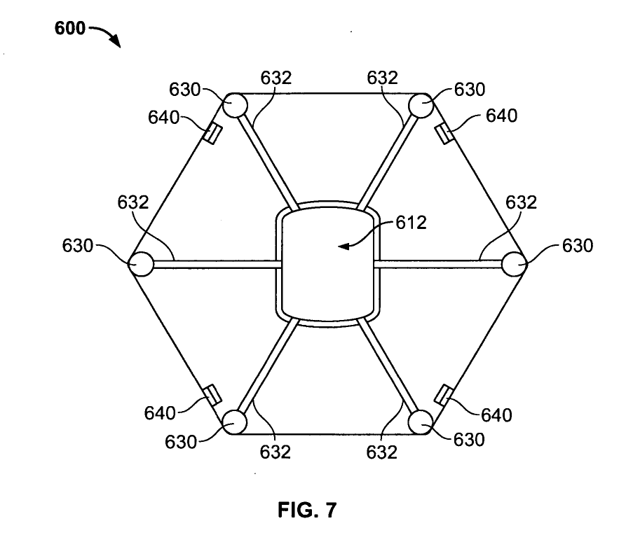

FIG. 6 illustrates a front view of a temperature sensor mounting component 600 according to an embodiment of the present invention. FIG. 7 illustrates a bottom view of a temperature sensor mounting component 600 according to an embodiment of the present invention. The mounting component 600 includes one or more temperature sensor mounting points 630 (shown in FIG. 7), one or more slots 632, an electronics cavity 612, and one or more mounting tabs 640.

Referring to FIGS. 6 and 7, the mounting component 600 may include and/or be connected to the main body 105 of a deicing system similar to deicing system 100, described above. The slots 632 connect one or more of the temperature sensor mounting points 630 to the electronics cavity 612. The electronics cavity 612 may be similar to the electronics cavity 112, described above.

In operation, the temperature sensor mounting points 630 may be used to mount one or more temperature sensors. The temperature sensors may be similar to temperature sensor 130, described above. The temperature sensors may be mounted using the temperature sensor mounting points 630 to be connected, coupled, and/or in close proximity to a heating element and/or plate, for example. For example, one or more temperature sensors may be thermally coupled to plate 142 to detect the temperature of a section of the plate 142. Alternatively, the temperature sensors may be connected and/or embedded in the plate 142 and the temperature senor mounting points 630 provide access to those temperature sensors.

The slots 632 may be channels, tubes, grooves, or the like in or connected to the mounting component 600. The slots 632 connect the temperature sensor mounting points 630 to the electronics cavity 612. Wires may be run through the slots 632 from the electronics cavity 612 to temperature sensors mounted in the temperature sensor mounting points 630. The slots 632 may hold and/or protect the wires connecting the temperature sensors 130 to the control unit 110, for example.

The mounting tabs 640 may be used to connect or attach the mounting component 600 to a heating element and/or plate such as the heating element 140 and/or the plate 142. When the mounting component 600 is connected to the heating element 140 and/or the plate 142 using the mounting tabs 640, temperature sensors mounted in the temperature sensor mounting points 630 may be coupled to or in close proximity to the heating element 140 and/or the plate 142.

In certain embodiments, the mounting component 600 may act as a heat shield between the heating element 140 and/or the plate 142 and the float 102. For example, the heating element 140 and/or the plate 142 may be connected to the bottom of the mounting component 600 using the tabs 640. In addition, the float 102 may be connected to the top of the mounting component 600. Thus, the mounting component 600 may be utilized, at least in part, as a heat shield similar to the heat shield 450, described above.

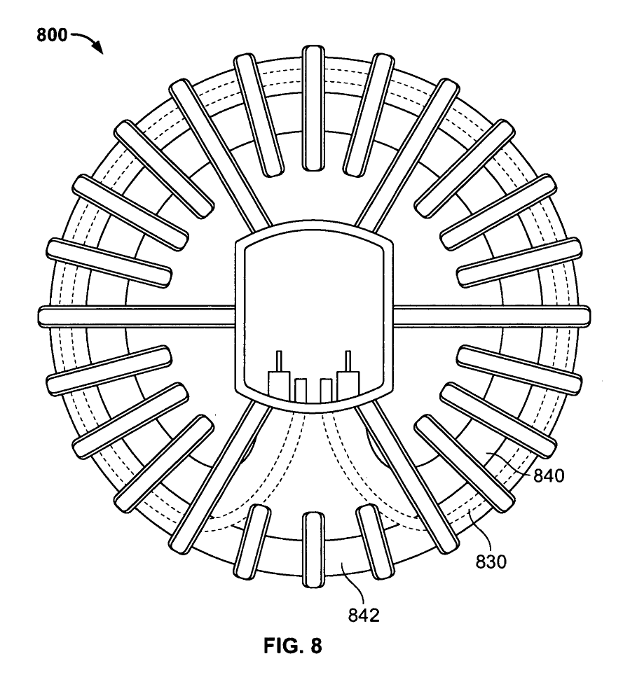

FIG. 8 illustrates a top view of a heater 800 for a deicing system according to an embodiment of the present invention. The heater 800 includes a heating element 840, a plate 842, and a tube 830. The heating element 840 is connected, embedded, encased, enclosed, in whole or in part, within the plate 842. The plate 842 may be aluminum, copper, or other element, alloy, or material capable of transferring heat from heating element 840 to a fluid. The tube 830 is connected, embedded, encased, enclosed, in whole or in part, within the plate 842.

The heater 800 may be similar to the heater 300, described above. The heating element 840 may be similar to the heating element 140 and/or the heating element 340, described above. The plate 842 may be similar to the plate 142 and/or the plate 342, described above.

In operation, one or more temperature sensors 130 and the leads and/or wiring to connect them to the control unit 110 may be pulled, strung, and/or placed within the tube 830. For example, the temperature sensors 130 and the associated wiring may be bundled into a cord with the temperature sensors 130 staggered so that when the cord is inserted into the tube 830, the temperature sensors will detect the temperature of different portions of the plate 842.

Rather than drilling holes into the plate 842 to provide mounting points for the temperature sensors 130, the tube 830 may be placed embedded in the plate 842 when the plate 842 is molded or cast, for example. The open ends of the tube 830 may extend into an electronics cavity such as electronics cavity 112. Thus, the temperature sensors 130 placed in the tube 830 may be connected to components in the electronics cavity 112 such as the control unit 110.

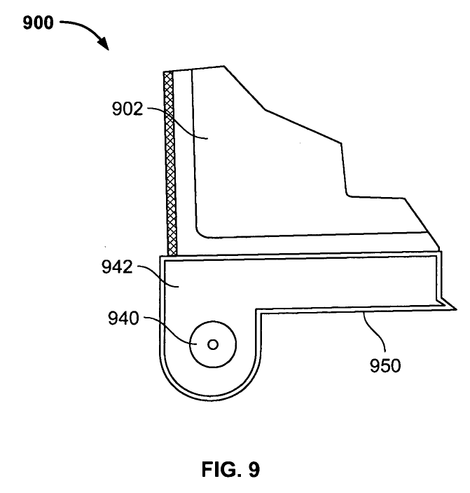

FIG. 9 illustrates a front cross-sectional view of a deicing system 900 according to an embodiment of the present invention. The deicing system 900 includes a float 902, a heating element 940, a plate 942, and a coating 950. The heating element 940 is embedded in the plate 942.

The deicing system 900 may be similar to the deicing system 100 and/or the deicing system 400, described above. The float 902 may be similar to the float 102 and/or the float 402, described above. The heating element 940 may be similar to the heating element 140, the heating element 340, the heating element 840, and/or the heating element 840, described above. The plate 942 may be similar to the plate 142, the plate 342, the plate 442 and/or the plate 842, described above.

The coating 950 is adapted to protect the surface of the plate 942 from pitting and/or reacting with the fluid in the fluid receptacle. The coating 950 is adapted to prevent the plate 842 from coming into contact with water and/or ions in the water such as chlorine. The coating is applied to some or all surfaces of the plate 942.

The coating 950 may be a fluoropolymer substance such as Teflon™ or Halar™, for example. Alternatively, the coating 950 may include thermoplastic copolymer coatings. By selecting various fluoropolymers or polymer combinations and the thickness of the coating, the amount of protection and the temperature response of the coatings can be optimized for the deicing system 900. For example, a 0.0001 inch coating of Teflon™ can significantly reduce pitting.

Thus, certain embodiments of the present invention provide effective transfer of heat to a fluid from a heater in a deicer. In addition, certain embodiments prevent heat from collecting around the float that may result in damage to the float and loss of buoyancy. Further, certain embodiments provide an improved coating of the heater and/or plate to suppress the reaction with ions in the water. Additionally, certain embodiments provide a temperature sensor mounting component. Certain embodiments provide a tube in the plate for mounting one or more temperature sensors.

While the invention has been described with reference to certain embodiments, it will be understood by those skilled in the art that various changes may be made and equivalents may be substituted without departing from the scope of the invention. In addition, many modifications may be made to adapt a particular situation or material to the teachings of the invention without departing from its scope. Therefore, it is intended that the invention not be limited to the particular embodiment disclosed, but that the invention will include all embodiments falling within the scope of the appended claims.

1. A deicer system for heating water within a fluid receptacle to prevent ice from forming, the system comprising:
a main body configured to be positioned within the fluid receptacle;
a heating element adapted to heat the water, wherein said heating element is supported by said main body, wherein said heating element includes a heating coil and a plate, wherein said plate includes one or more fins;
a temperature sensor adapted to detect a temperature of said heating element;
a switch adapted to activate and deactivate said heating element; and
a control unit in communication with said heating element, said temperature sensor, and said switch, wherein said control unit is adapted to control said heating element using said switch based at least in part on a temperature detected by said temperature sensor.

2. The system of claim 1, wherein said temperature sensor includes at least one of a thermistor, thermocouple, resistance temperature detector, thermometer, and silicon bandgap temperature sensor.

3. The system of claim 1, wherein said control unit comprises at least one of a processor, a microprocessor, an integrated circuit, and a plurality of discrete logic components.

4. The system of claim 1, further including a plurality of temperature sensors in electrical communication with said control unit.

5. The system of claim 4, wherein said control unit is adapted to monitor said plurality of temperature sensors.

6. The system of claim 5, wherein said control unit is adapted to deactivate said heating element based at least in part on said monitored temperature sensors.

7. The system of claim 1, wherein said heating element further includes a tube embedded within said heating element, wherein said temperature sensor is located within said tube.

8. The system of claim 4, wherein said heating element further includes a tube embedded within said heating element, wherein said plurality of temperature sensors is located within said tube.

9. The system of claim 4, further including a temperature sensor mounting component, wherein said temperature sensor mounting component is adapted to mount said plurality of said temperature sensors such that each temperature sensor in said plurality of said temperature sensors monitors a temperature of a section of said heating element.

10. The system of claim 9, wherein said temperature sensor mounting component includes slots for a plurality of leads to electrically couple said plurality of temperature sensors with said control unit.

11. The system of claim 8, further including a float, wherein said temperature sensors mounting component is adapted to act as a heat shield between said heating element and said float.

12. The system of claim 1, wherein said fins are adapted to increase the surface area of the heating element.

13. The system of claim 1, wherein said fins are adapted to lower a surface temperature of said plate.

14. The system of claim 14, wherein said heating element is powered with at least 1000 watts and wherein said plate dissipates less than 16 watts per square inch.

15. The system of claim 1, wherein said heating element is coated at least in part with a coating, wherein said coating is adapted to prevent said heating element from reacting with the fluid.

16. The system of claim 15, wherein said coating includes at least one of a fluoropolymer and a thermoplastic copolymer.

17. A deicer system for heating water within a fluid receptacle to prevent ice from forming, the system comprising:
a main body configured to be positioned within the fluid receptacle;
a heating element adapted to heat the water, wherein said heating element is supported by said main body, wherein said heating element includes a heating coil and a plate;
a float adapted to make the deicing system buoyant; and
a heat shield located at least in part between said heating element and said float.

18. The system of claim 17, wherein said heat shield is adapted to reduce the transmission of heat from said heating element to said float.

19. The system of claim 17, wherein said heating element is positioned so that the water flows between said heating element and said heat shield.

20. A deicer system for heating water within a fluid receptacle to prevent ice from forming, the system comprising:
a main body configured to be positioned within the fluid receptacle; and
a heating element adapted to heat the water, wherein said heating element is supported by said main body, wherein said heating element includes a heating coil and a plate, wherein said plate includes fins to increase the surface area of said plate, and wherein said plate is adapted to allow the water to flow over top, bottom, and side surfaces of said plate.
